(19) United States
(12) Patent Application Publication
(10) Pub. No.: US 2011/0285627 A1
(43) Pub. Date: Nov. 24, 2011

(54) INPUT DEVICE AND GAMING APPARATUS HAVING SAME

(75) Inventors: HAI LAN, Tu-Cheng (TW); GA-LANE CHEN, Santa Clara, CA (US)

(73) Assignee: HON HAI PRECISION INDUSTRY CO., LTD., Tu-Cheng (TW)

(21) Appl. No.: 12/839,361

(22) Filed: Jul. 19, 2010

(30) Foreign Application Priority Data
May 20, 2010 (TW) 99116042

(51) Int. Cl. G06F 3/033; G09G 5/00

(52) U.S. Cl. 345/161; 345/156

(57) ABSTRACT

An input device includes a moveable manipulation portion, a magnetic-field generating unit, a pressure-detecting unit, a magnetic sensor, and a processing unit. The moveable manipulation portion includes a pressing surface. The magnetic-field generating unit provides a predetermined magnetic field. The pressure-detecting unit includes a detecting surface facing the pressing surface. The manipulation portion is moveably arranged on the pressure-detecting unit. The pressure-detecting unit detects and converts a pressure applied by the manipulation portion to the detecting surface into electrical signals. The magnetic sensor is fixedly attached to the manipulation portion and detects the magnetic field at different locations of the manipulation portion so as to determine a movement trace of the manipulation portion relative to the magnetic-field generating unit. The processing unit generates a control signal associated with a movement of a character according to the movement trace of the manipulation portion and the electrical signals.

### BACKGROUND

1. Technical Field

The present disclosure relates to input devices and gaming apparatuses having the same.

2. Description of Related Art

One of the many different video games that have been developed recently is a three-dimension game. A typical input device does not meet the user requirements for this game or allow the user to properly control the gaming roles in this three-dimension game. This can be very disappointing and frustrating for the user.

Therefore, an input device and a gaming apparatus, which can overcome the above-mentioned problems, are needed.

### BRIEF DESCRIPTION OF THE DRAWINGS

FIG. 1 is a schematic view of a gaming apparatus including an input device, according to a first embodiment.

FIG. 2 is a partially planar view of the input device of FIG. 1.

FIG. 3 is a schematic view of a gaming apparatus, according to a second embodiment.

### DETAILED DESCRIPTION

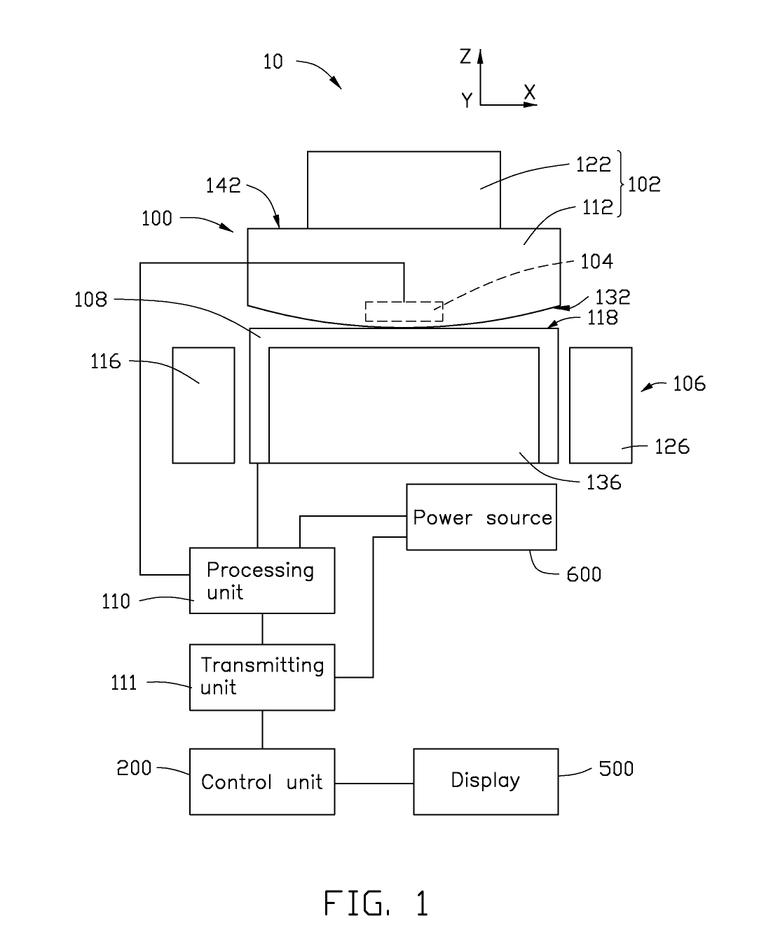

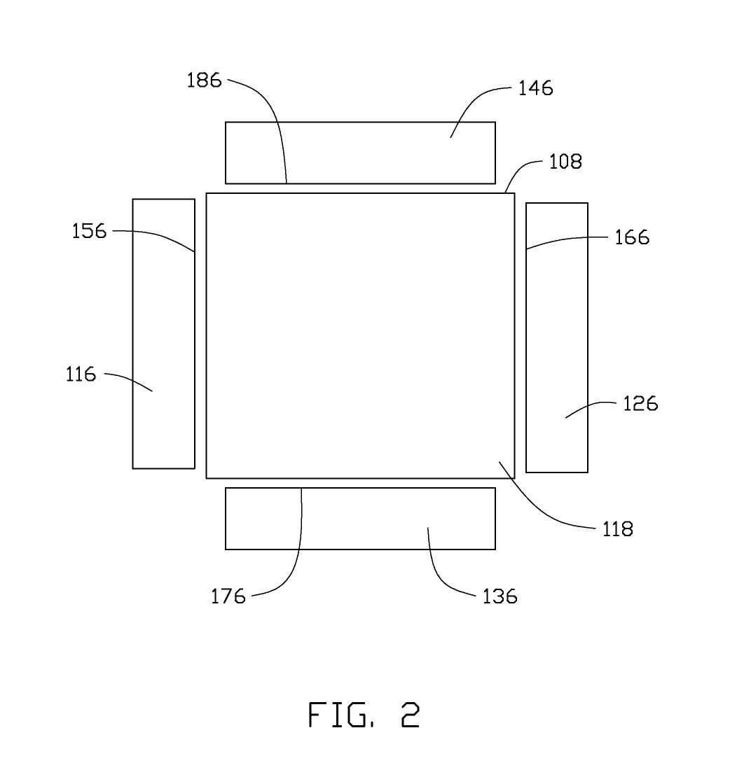

Referring to FIGS. 1-2, a gaming apparatus 10, according to a first embodiment, includes an input device 100 and a control unit 200. Games launched by the gaming apparatus 10 can be displayed on a display 500.

The input device 100 includes a manipulation portion 102, a magnetic sensor 104, a magnetic-field generating unit 106, a pressure-detecting unit 108, a processing unit 110, and a transmitting unit 111. The input device 100 can be powered by a power source 600, which may be battery units.

The manipulation portion 102 is moveably arranged on the pressure-detecting unit 108. Specifically, the manipulation portion 102 moves along X, Y, Z axes of a coordinates system shown in FIG. 1. The Y axis is perpendicular to the surface of the paper. In this embodiment, the manipulation portion 102 includes a pressing button 112 and a contact button 122 formed on the pressing button 112. The pressing button 112 is integrally formed with the contact button 122 in this embodiment.

The pressing button 112 includes a pressing surface 132 and a supporting surface 142 opposite to the pressing surface 132. The pressing surface 132 is curved, such as spherical or aspherical. The contact button 122 is formed on the supporting surface 142. A user may contact the contact button 122 to control movement of the manipulation portion 102.

The magnetic-field generating unit 106 is configured for providing a predetermined magnetic-field. The magnetic-field generating unit 106 includes a first magnet 116, a second magnet 126, a third magnet 136 and a fourth magnet 146. The four magnets 116, 126, 136, 146 are arranged in a rectangular fashion and surround the pressure-detecting unit 108, as shown in FIG. 2.

The first magnet 116 and the second magnet 126 are positioned at two opposite sides of the pressure-detecting unit 108. The third magnet 136 and the fourth magnet 146 are positioned at other two opposite sides of the pressure-detecting unit 108.

The first magnet 116 includes a first magnetic pole 156 facing the pressure-detecting unit 108. The second magnet 126 includes a second magnetic pole 166 facing the pressure-detecting unit 108. The third magnet 136 includes a third magnetic pole 176 facing the pressure-detecting unit 108. The fourth magnet 146 includes a fourth magnetic pole 186 facing the pressure-detecting unit 108. In this embodiment, the first magnetic pole 156 is opposite to the second magnetic pole 166. The third magnetic pole 176 is opposite to the fourth magnetic pole 186.

The magnetic sensor 104 is fixedly attached to the manipulation portion 102. In this embodiment, the magnetic sensor 104 is embedded in the pressing button 112 and is configured for detecting the magnetic field at different locations of the manipulation portion so as to determine a movement trace of the manipulation portion 102 relative to the magnetic-field generating unit 106. Specifically, since the four magnets 116, 126, 136, 146 are positioned in the above fashion, the magnetic field generated by the magnetic-field generating unit 106 in space is constant. The magnetic field in space can be measured/determined by designers/manufacturers after the magnets 116, 126, 136, 146 are positioned. The magnetic sensor 104 in different positions in the magnetic field detects different magnetic field, such as magnetic density, corresponding to the positions of the magnetic sensor 104. When the manipulation portion 102 moves together with the magnetic sensor 104, then magnetic sensor 104 detects changes of the magnetic field to determine the movement of the manipulation portion 102.

The pressure-detecting unit 108 includes a detecting surface 118 facing the pressing surface 132. The detecting surface 118 is a planar surface. The pressure-detecting unit 108 is configured for detecting and converting a pressure applied by the manipulation portion 102 to the detecting surface 118 into electrical signals. The pressure-detecting unit 108 may be a micro-electro-mechanical system (MEMS) detecting unit. The MEMS is the integration of mechanical elements, sensors, actuators, and electronics on a common silicon substrate through micro-fabrication.

The processing unit 110 is configured for generating a control signal associated with a movement of a character according to the movement trace of the manipulation portion 102 and the electrical signals. The transmitting unit 111, a BLUETOOTH device, is configured for sending out the control signals to the control unit 200. In this embodiment, the transmitting unit 111 communicates with the control unit 200 wireless.

The control unit 200 is configured for controlling and displaying the movement of the character on the display 500 according to the control signals. The control unit 200 may be a game host. The control unit 200 has output/input interfaces to allow the control unit 200 to communicate with peripherals, such as the transmitting unit 111 and the display 500.

The operation of the gaming device 10 is launched by the gaming device 10 and displayed on the display 500. The input device 100 is held with one finger placed on the manipulation portion 102. The manipulation portion 102 is then moved along the X axis, thereby controlling the character in the jumping game to move forwards. When the character arrives at a predetermined position in the game, the manipulation portion 102 is depressed to control the character to jump over the jump rope. During the above process, the movement of the manipulation portion 102 along the X axis causes changes of the magnetic field detected by the magnetic sensor 104. The processing unit 110 generates control signals associated with the movement of the character according to the movement of the manipulation portion 102. The control signals are sent out to the control unit 200 through the transmitting unit 111. The control unit 200 controls and displays the movement of the character on the display 500.

The pressure-detecting unit 108 detects the pressure applied by the manipulation portion 102 to the detecting surface 118 and converts the pressure into electrical signals. The electrical signals include information of magnitude of the pressure. The magnitude of the pressure represents a jumping height of the character. The processing unit 110 sends out the electrical signals to the control unit 200 through the transmitting unit 111. The control unit 200 controls and displays the character jumping on the display 500.

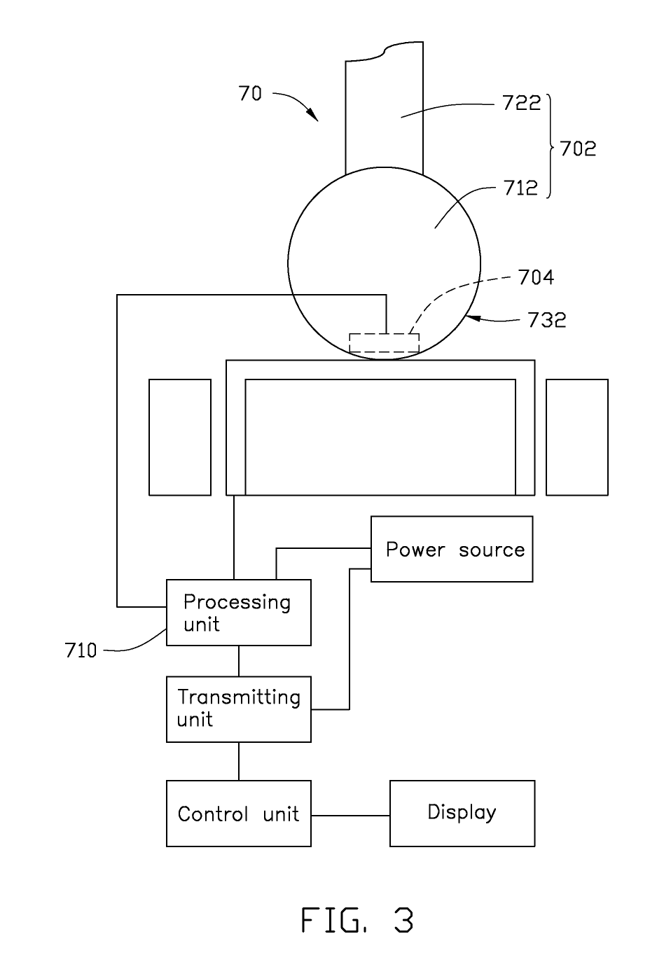

Referring to FIG. 3, a gaming apparatus 70, according to a second embodiment, is shown. The difference between the gaming apparatus 70 of this embodiment and the gaming apparatus 10 is that: a manipulation portion 702 of the gaming apparatus 70 is different.

In this embodiment, the manipulation portion 702 includes a pressing ball 712 and a control stick 722. A magnetic sensor 704 is embedded in the pressing ball 712. A processing unit 710 is electrically connected to the magnetic sensor 704. The pressing ball 712 includes a pressing surface 732. The control stick 722 is fixed to the pressing ball 712. The control stick 722 is held to rotate the pressing ball 712. The rotation of the pressing ball 712 causes changes of magnetic field detected by the magnetic sensor 704. Therefore, the movement of the manipulation portion 702 can be detected.

Since three-dimension movement of the character can be inputted by the gaming apparatus, people can better enjoy the three-dimensional game.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An input device, comprising:
a moveable manipulation portion comprising a pressing surface;
a magnetic-field generating unit configured for providing a predetermined magnetic field;
a pressure-detecting unit comprising a detecting surface facing the pressing surface, the manipulation portion moveably arranged on the pressure-detecting unit, the pressure-detecting unit configured for detecting and converting a pressure applied by the manipulation portion to the detecting surface into electrical signals;
a magnetic sensor fixedly attached to the manipulation portion and configured for detecting the magnetic field at different locations of the manipulation portion so as to determine a movement trace of the manipulation portion relative to the magnetic-field generating unit; and
a processing unit configured for generating a control signal associated with a movement of a character according to the movement trace of the manipulation portion and the electrical signals.

2. The input device of claim 1, wherein the manipulation portion comprises a pressing button and a contact button formed on the pressing button, the pressing button comprising the pressing surface and a supporting surface opposite to the pressing surface, the contact button formed on the supporting surface, the magnetic sensor embedded in the pressing button.

3. The input device of claim 2, wherein the pressing button is integrally formed with the contact button.

4. The input device of claim 1, wherein the magnetic-field generating unit comprises at least two magnets, the pressure-detecting unit positioned between the at least two magnets.

5. The input device of claim 4, wherein the at least two magnets comprises a first magnet and a second magnet at opposite sides of the pressure-detecting unit, the first magnet comprising a first magnetic pole facing the pressure-detecting unit, the second magnet comprising a second magnetic pole facing the pressure-detecting unit, the first magnetic pole opposite to the second magnetic pole.

6. The input device of claim 1, wherein the manipulation portion comprises a pressing ball and a control stick, the pressing ball comprising the pressing surface, the control stick fixed to the pressing ball, the magnetic sensor embedded in the pressing ball.

7. The input device of claim 1, further comprising a transmission unit configured for sending out the control signals.

8. A gaming apparatus, comprising:
an input device comprising:
a moveable manipulation portion comprising a pressing surface;
a magnetic-field generating unit configured for providing a predetermined magnetic field;
a pressure-detecting unit comprising a detecting surface facing the pressing surface, the manipulation portion moveably arranged on the pressure-detecting unit, the pressure-detecting unit configured for detecting and converting a pressure applied by the manipulation portion to the detecting surface into electrical signals;
a magnetic sensor fixedly attached to the manipulation portion and configured for detecting the magnetic field at different locations of the manipulation portion so as to determine a movement trace of the manipulation portion relative to the magnetic-field generating unit; and
a processing unit configured for generating a control signal associated with a movement of a character according to the movement trace of the manipulation portion and the electrical signals; and
a control unit configured for controlling and displaying the movement of the character on a display device according to the control signals.

9. The gaming apparatus of claim 8, wherein the manipulation portion comprises a pressing button and a contact button formed on the pressing button, the pressing button comprising the pressing surface and a supporting surface opposite to the pressing surface, the contact button formed on the supporting surface, the magnetic sensor embedded in the pressing button.

10. The gaming apparatus of claim 9, wherein the pressing button is integrally formed with the contact button.

11. The gaming apparatus of claim 8, wherein the magnetic-field generating unit comprises at least two magnets, the pressure-detecting unit positioned between the at least two magnets.

12. The gaming apparatus of claim 11, wherein the at least two magnets comprises a first magnet and a second magnet at opposite sides of the pressure-detecting unit, the first magnet comprising a first magnetic pole facing the pressure-detecting unit, the second magnet comprising a second magnetic pole facing the pressure-detecting unit, the first magnetic pole opposite to the second magnetic pole.

13. The gaming apparatus of claim 8, wherein the manipulation portion comprises a pressing ball and a control stick, the pressing ball comprising the pressing surface, the control stick fixed to the pressing ball, the magnetic sensor embedded in the pressing ball.

14. The gaming apparatus of claim 8, further comprising a transmission unit configured for sending out the control signals.

15. A gaming apparatus, comprising:
a joy stick comprising:
a manipulation portion comprising a pressing surface;
a magnetic-field generating unit configured for providing a constant magnetic field;
a pressure-detecting unit comprising a detecting surface for facing the pressing surface, the manipulation portion configured to move on the pressure-detecting unit, the pressure-detecting unit configured for detecting and converting pressures applied by the manipulation portion to the detecting surface into electrical signals associated with the pressures;
a magnetic sensor fixedly attached to the manipulation portion and configured for measuring the magnetic field at different locations of the manipulation portion so as to determine a movement trace of the manipulation portion; and
a processing unit configured for generating control signals associated with a movement of a game character according to the movement trace of the manipulation portion and the electrical signals; and
a control unit configured for controlling the movement of the character on a display device according to the control signals.
